(19) United States
(12) Patent Application Publication
(10) Pub. No.: US 2011/0241824 A1
(43) Pub. Date: Oct. 6, 2011

(54) IN-VEHICLE MOUNT TYPE BATTERY CHARGING SYSTEM, MANAGING SERVER, MANAGING SERVER CONTROL METHOD AND COMPUTER-READABLE MEDIUM STORING PROGRAM FOR MANAGING SERVER

(75) Inventor: Kenichiro UESUGI, Moriya-shi (JP)

(73) Assignees: Motion Co., Ltd., Tokyo (JP); Kanematsu Communications Limited, Tokyo (JP); Kanematsu Corporation, Kobe-shi (JP)

(21) Appl. No.: 13/074,072

(22) Filed: Mar. 29, 2011

(30) Foreign Application Priority Data
Mar. 31, 2010 (JP) 2010-080004

(51) Int. Cl. G06F 7/04; H02J 7/00

(52) U.S. Cl. 340/5.8; 320/109

(57) ABSTRACT

An in-vehicle mount type battery charging system including a charging station having a charger for charging an in-vehicle mount battery of an electric vehicle, and a managing server connected to the charger. The managing server receives registration for enabling use of the charger from a user, authenticates the user when the user uses the charger and allows the user to use the charger when the user is authenticated as a registered member. Furthermore, the managing server receives temporary registration for temporarily enabling use of the charger from a user as a nonmember, authenticates the user when the user uses the charger and temporarily allows the user to use the charger when the user is authenticated as a registered temporary member.

### INCORPORATION BY REFERENCE

The present application claims priority under 35 U.S.C. §119 to Japanese Patent Application No. 2010-080004 filed on Mar. 31, 2010. The content of the application is incorporated herein by reference in its entirety.

### BACKGROUND OF THE INVENTION

1. Field of the Invention

The present invention relates to a managing server which is connected to a charger for charging an in-vehicle mount battery of an electric vehicle so as to be able to communicate with the charger, an in-vehicle mount type battery charging system having the managing server, a method of controlling the managing server and a computer-readable medium storing a program for controlling the managing server.

2. Description of the Related Art

A charging station for charging an in-vehicle mount type battery of an electric vehicle is known (for example, see JP-A-07-115732). This type of charging station is implemented on the assumption that it is operated under an unmanned condition without staffing any servicing person in a charging station because of conditions of location, operating expense, etc. of the charging station. In this case, in order to surely perform accounting caused by use of the charging station, it is considered that only members who have been registered in advance are allowed to use charging stations.

By the way, there occurs such a case that it is required to charge an in-vehicle mount battery as early as possible because the residual capacity of the in-vehicle battery decreases under running of a vehicle irrespective of a member or a nonmember. In this case, according to a system in which only pre-registered members are allowed to use charging stations, nonmembers cannot use any charging station even under the condition that the residual capacity of the battery decreases. Therefore, convenience of the system to users is lost, and this unavailability may disturb propagation of electric vehicles.

### SUMMARY OF THE INVENTION

The present invention has been implemented in view of the foregoing situation, and has an object to provide a convenience-enhanced in-vehicle mount type charging system, a managing server, a managing server control method and a computer-readable medium storing a program.

In order to attain the above object, there is provide an in-vehicle mount type battery charging system comprising: a charging station having a charger for charging an in-vehicle mount battery of an electric vehicle; and a managing server that is connected to the charger of the charging station so that communications can be performed between the managing server and the charger, wherein the managing server has a member authenticating function of receiving registration for enabling use of the charger from a user, authenticating the user when the user uses the charger and allowing the user to use the charger when the user is authenticated as a registered member, and a temporary member authenticating function of receiving temporary registration for temporarily enabling use of the charger from a user as a nonmember, authenticating the user when the user uses the charger and temporarily allowing the user to use the charger when the user is authenticated as a registered temporary member.

According to this construction, not only pre-registered members, but also temporary members can use the charging station, and thus the nonmembers can charge their in-vehicle mount batteries in the charging station. Therefore, the convenience of the in-vehicle mount type battery charging system can be enhanced.

The above in-vehicle mount type battery charging system may further comprise a lock unit for locking connection between the charger and the in-vehicle mount battery, wherein when a user uses the charger, the connection between the charger and the in-vehicle mount battery is locked by the lock unit in accordance with user's instruction of starting charging under a condition that the user is authenticated as any one of a registered member and a registered temporary member by the managing server, and when a user releases the lock of the connection between the charger and the in-vehicle mount battery by the lock unit, the lock of the connection by the lock unit is released under a condition that the managing server authenticates the user as a user who starts the charging.

According to this construction, in order for the user to release the lock of the connection between the charger and the in-vehicle mount battery, the user is required to be authenticated as a user who starts charging, and thus another person can be prevented from release the connection between the charger and the in-vehicle mount battery without any user's consent to charge the in-vehicle mount battery of the other person's electric vehicle during charging.

Particularly, as compared with supplement of gasoline at a gasoline station, the charging time required for the charge based on the charger in the charging station trends to be longer, and thus the user may be away from the charging station during charging. In this case, the above construction is particularly effective.

Furthermore, in the above in-vehicle mount type battery charging system, the temporary registration of the managing server may be set to be valid for a fixed period.

Here, the fixed period is properly set in accordance with the type and the characteristic of the temporary member. In consideration of this, the temporary member registration can be set to be valid for the fixed period which is properly determined in accordance with the type and characteristic of the temporary member.

Still furthermore, in the above in-vehicle mount type battery charging system, the managing server may be configured to receive temporary member registration from a user through a portable terminal, and the managing server may be provided with a charging station searching unit for searching charging stations available to a user on the basis of position information of the portable terminal and outputting information concerning the searched charging stations to the user through the portable terminal when the managing server receives temporary member registration from the user.

According to this construction, when temporary member registration is performed, the user can obtain information concerning available charging stations which is useful for determination as to whether the user is registered as a temporary member, and thus the convenience for users can be enhanced.

In the above in-vehicle mount type battery charging system, the managing server may be further provided with a one-time password issuing unit for generating a one-time password for a temporary member and allocating the generated one-time password to a user when the managing server receives temporary member registration from the user, the charging station may be provided with a user interface to which the user can input the one-time password allocated to the user concerned, and when a user uses the charger, the managing server may determine on the basis of comparison between the one-time password input through the user interface by the user and the one-time password generated by the one-time password issuing unit whether the user has been registered as a temporary member.

According to this construction, the temporary member registration can be properly performed on the user who requests the temporary member registration, and the user as a temporary member can surely use the charger.

Furthermore, in the above in-vehicle mount type battery charging system, the managing server may be further provided with an authentication code issuing unit for generating an authentication code uniquely allocated to a user and outputting the generated authentication code to the user when the managing server receives temporary member registration from the user, the charging station may be provided with an authentication code reading device for reading an authentication code, and the managing server may determine on the basis of the authentication code read out by the authentication code reading device whether the user has been registered as a temporary member.

According to this construction, when the user is authenticated, the user may make the authentication code reading device read the authentication code output to the user. Accordingly, as compared with the case where the user is required to input his/her password or the like for authentication, the work imposed on the user for authentication can be reduced, and the convenience for users can be enhanced.

In the above in-vehicle mount type battery charging system, the charging station may be provided with a card reading device that can read a card ID from an authentication card. When a user whose card ID is not stored is authenticated, the managing server may acquire the card ID of the authentication card by the card reading device in combination with the authentication of the user, store the acquired card ID in association with user information containing at least information concerning whether the user is a temporary member or not, and when a user whose card ID is stored is authenticated, the managing server may acquire the card ID of the authentication card by the card reading device, and authenticate the user on the basis of user information stored in association with the read card ID.

Here, the authentication card has a broad concept containing a card having card ID which is uniquely allocated every card, and contact type or non-contact type IC cards, magnetic stripe cards, etc. may be adopted as authentication cards. Furthermore, the shape of the authentication card is not limited to the card-like shape, and it may contain a cellular phone having a non-contact IC chip which can execute near field wireless communication in conformity with a predetermined communication standard (protocol).

According to this construction, after the card ID is once stored by the managing server, with respect to authentication of a user possessing an authentication card corresponding to the card ID concerned, the authentication of the user is performed on the basis of the stored card ID. Accordingly, the user may make the card reading device read the authentication card owned by the user, and the work required to the user for authentication can be reduced as compared with the case where the user is required to input his/her password or the like for authentication, so that the convenience for users can be enhanced.

In the above in-vehicle mount type battery charging system when receiving temporary member registration from a user, the managing server may request the user to input necessary matters for the temporary member registration, and select on the basis of the input necessary matters whether the user should be registered as a temporary member.

According to the above construction, on the basis of the necessary matters, it is properly determined whether the user is allowed to use the charger, and then the it is properly determined whether the user concerned is registered as a temporary member.

In the above in-vehicle mount type battery charging system, the necessary matters may contain a matter for identifying whether accounting can be applied to the user or not, and when receiving temporary member registration from a user, the managing server may request the user to input necessary matters, determine on the basis of the input necessary matters whether accounting can be applied to the user, and register the user as a temporary member when it is determined that accounting can be applied to the user.

According to the above construction, when accounting can be performed on the user, the temporary member registration of the user can be performed, and thus the user as a temporary member who uses the charger of the charging station can be surely charged.

In order to attain the above object, there is provided a managing server that is connected to a charger provided in a charging station to charge an in-vehicle mount battery of an electric vehicle so that communications can be performed between the managing server and the charger, wherein the managing server has a member authenticating function of receiving registration for enabling use of the charger from a user, authenticating the user when the user uses the charger and allowing the user to use the charger when the user is authenticated as a registered member, and a temporary member authenticating function of receiving temporary registration for temporarily enabling use of the charger from a user as a nonmember, authenticating the user when the user uses the charger and temporarily allowing the user to use the charger when the user is authenticated as a registered temporary member.

Furthermore, in order to attain the above object, there is provided a method of controlling a managing server that is connected to a charger provided in a charging station to charge an in-vehicle mount battery of an electric vehicle so that communications can be performed between the managing server and the charger, and comprises: receiving registration for enabling use of the charger from a first user; authenticating the first user when the first user uses the charger; allowing the first user to use the charger when the first user is authenticated as a registered member; receiving temporary registration for temporarily enabling use of the charger from a second user as a nonmember; authenticating the second user when the second user uses the charger; and temporarily allowing the second user to use the charger when the second user is authenticated as a registered temporary member.

In order to attain the above object, there is provided a medium storing a computer-readable program for making a computer execute a procedure comprising the steps of: receiving registration for enabling use of the charger from a first user; authenticating the first user when the first user uses the charger; allowing the first user to use the charger when the first user is authenticated as a registered member; receiving temporary registration for temporarily enabling use of the charger from a second user as a nonmember; authenticating the second user when the second user uses the charger; and temporarily allowing the second user to use the charger when the second user is authenticated as a registered temporary member.

According to the present invention, the battery charging system which is enhanced in convenience for users can be provided.

### BRIEF DESCRIPTION OF THE DRAWINGS

FIG. 1 is a block diagram showing the construction of an in-vehicle mount type battery charging system according to a first embodiment;

FIG. 2 is a block diagram showing the functional construction of a charger;

FIG. 3 is a block diagram showing the functional construction of a managing server;

FIG. 4 is a sequence flowchart of the in-vehicle mount type battery charging system;

FIG. 5 is a sequence flowchart of the in-vehicle mount type battery charging system;

FIG. 6 is a diagram showing an example of a temporary member registering site;

FIG. 7 is a diagram showing the construction of a temporary member DB;

FIG. 8 is a block diagram showing the functional construction of a charger according to a second embodiment;

FIG. 9 is a block diagram showing the functional construction of a managing server;

FIG. 10 is a diagram showing the construction of the temporary member DB; and

FIG. 11 is a block diagram showing the functional construction of a managing server according to a third embodiment.

### DETAILED DESCRIPTION OF THE PREFERRED EMBODIMENTS

Preferred embodiments according to the present invention will be described hereunder with reference to the accompanying drawings.

### First Embodiment

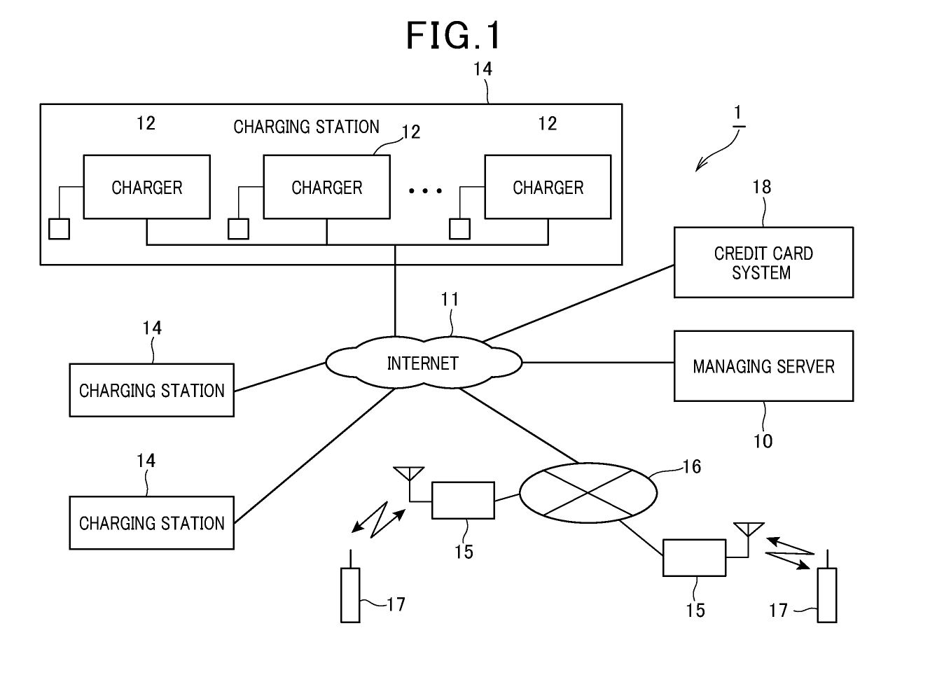

FIG. 1 is a block diagram showing the construction of an in-vehicle mount type charging system 1 according to a first embodiment.

The in-vehicle mount type battery charging system 1 has a managing server 10, and plural chargers 12 connected to the managing server 10 through the Internet 11.

Plural chargers 12 are provided for each charging station 14. Each charging station 14 is placed to charge in-vehicle mount batteries of electric vehicles, and a user (driver or the like) of an electric vehicle can arbitrarily charge the in-vehicle mount battery thereof by using a charger 12 installed in each charging station 14 in accordance with decrease of the residual capacity of the in-vehicle mount battery during running of the electric vehicle. According to this embodiment, only members who have been pre-registered can basically utilize the charging stations 14 as described later.

Furthermore, in the in-vehicle mount battery charging station 1, a cellular phone 17 (portable terminal) is connected to a managing server 10 through a telephone line network 16 connected to a basic station 15 and the Internet 11 so that communications can be performed between the cellular phone 17 and the managing server 10. A credit card system 18 described later is connected to the managing server 10 through the Internet 11.

In this embodiment, communications based on a predetermined encryption protocol or secure communications based on an existing technique such as a virtual exclusive line or the like are implemented between the managing server 10 and another equipment. Here, it is needless to say that the managing server 10 and another equipment (for example, a charger 12) may be connected to each other through an exclusive line to perform communications between the managing server 10 and the other equipment through the exclusive line.

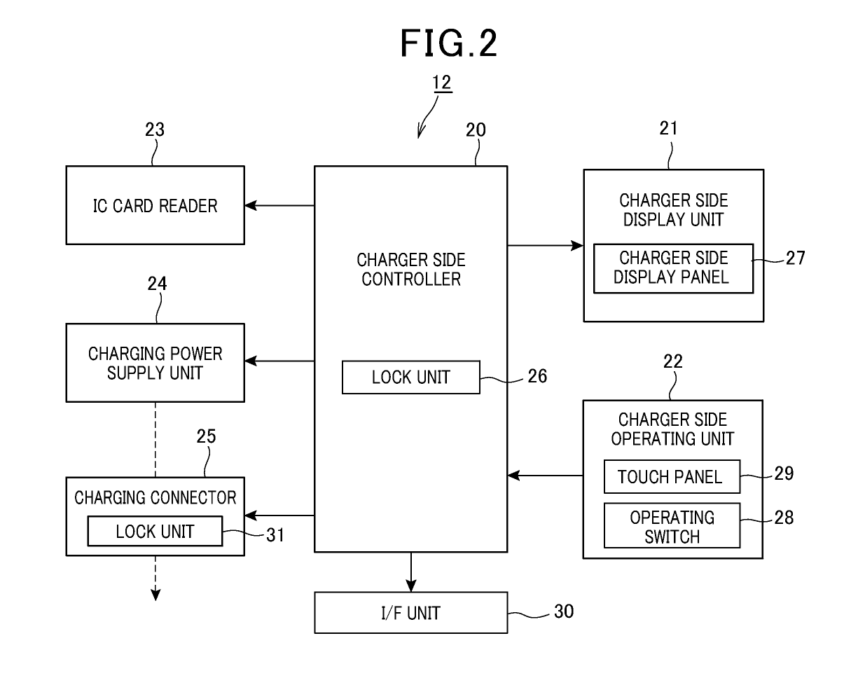

FIG. 2 is a block diagram showing the functional construction of the charger 12.

As shown in FIG. 2, the charger 12 has a charger side controller 20, a charger side display unit 21, a charger side operating unit 22, an IC card reader 23 (IC card reading device), a charging power supply unit 24, a charging connector 25 and an interface unit 30.

The charger side controller 20 concentrically controls each part of the charger 12, and it has CPU as an operation executing unit, ROM for storing a computer-readable basic control program to be executed by CPU in a non-volatile style, RAM for temporarily storing programs to be executed by CPU, data associated with the programs, etc., other peripheral circuits, etc. The charger side controller 20 has a lock unit 26, and this will be described later.

The charger side display unit 21 has a charger side display panel 27 such as a liquid crystal display panel or the like, and displays various kinds of information on the charger side display panel 27 under the control of the charger side controller 20.

An operation switch 28 provided to the charger 12 is connected to the charger side operating unit 22, and the charger side operating unit 22 detects an operation of the operation switch 28 executed by a user, a worker or the like and outputs an operation signal representing the operation to the charger side controller 20. The charger side operating unit 22 is connected to a touch panel (user interface) disposed to be laminated on the charger side display panel 27. When a touch operation executed on the touch panel 29 is detected, the charger side operating unit 22 outputs a position signal representing the touch operation position to the charger side controller 20.

The IC card reader 23 is a reading device of a non-contact IC card (hereinafter referred to as “IC card”). The IC card reader 23 performs near field communication with an IC card in conformity with a predetermined standard (for example, Felica (registered trademark)) and reads various kinds of information containing a card ID from the IC card. The card ID is ID which is uniquely allocated every IC card, and it is stored as data in a non-volatile memory such as EEPROM, RRAM or the like which is mounted in the IC card.

In this embodiment, the noncontact IC card is not limited to a card-shaped card, and it may be equipment such as a cellular phone or the like in which a noncontact IC chip is mounted. That is, the noncontact IC card is designed on the concept that it contains a medium which can perform near field communication with the IC card reader 23.

Furthermore, in this embodiment, a card reader which can read an IC card based on the standard having a high prevalence rate is used as the IC card reader 23. Accordingly, many users can utilize IC card readers 23, and thus the convenience for users is enhanced. Here, it is needless to say that plural IC card readers 23 which can read IC cards conforming to different standards may be provided.

Still furthermore, the IC card reader 23 according to this embodiment is a reading device for noncontact IC cards. However, the IC card reader 23 of this embodiment is not limited to a reading device for noncontact IC cards, and it may be a reading device for contact type IC cards or a reading device for magnetic type cards. That is, the reading device of the present invention is not limited to the IC card reader 23, and different types of reading devices for different types cards to be read, such as a noncontact IC card, a magnetic stripe card, etc. may be individually provided in accordance with needs of users or the like. For example, a reading device which can read magnetic cards containing magnetic type credit cards may be provided.

The charging power supply unit 24 is connected to chargers (not shown). Under the control of the charger side controller 20, power from each kind of power source is properly subjected to transformation of electrical energy and supplied to an in-vehicle battery of an electric vehicle which is connected to a charging connector 25. The charging station 14 may be provided with chargers, and the charging power supply unit 24 may supply power stocked in each of the chargers to the in-vehicle battery of the electric vehicle.

The charging connector 25 is designed to be physically and electrically connectable to a connector provided at the in-vehicle mount battery side of the electric vehicle. The charging connector 25 is provided with a lock mechanism 31. The lock mechanism 31 locks or unlocks the connection between the charging connector 25 and the connector at the in-vehicle mount battery side under the control of the lock unit 26 provided to the charger side controller 20. An interface unit 30 performs communications in conformity with a predetermined communication standard (protocol) under the control of the charger side controller 20.

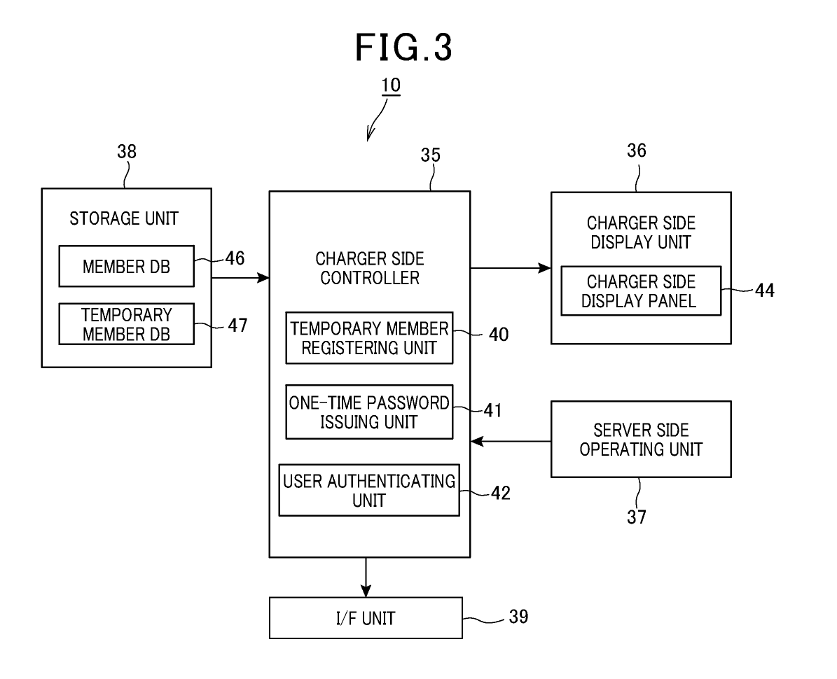

FIG. 3 is a block diagram showing the functional construction of the managing server 10.

As shown in FIG. 3, the managing server 10 has a server side controller 35, a server side display unit 36, a server side operating unit 37, a storage unit 38 and an interface unit 39.

The server side controller 35 concentrically controls each part of the managing server 10, and it has CPU, ROM, RAM, other peripheral circuits, etc. as in the case of the charger side controller 20 described above. As shown in FIG. 3, the server side controller 35 has a temporary member registering unit 40, a one-time password issuing unit 41 and a user authentication unit 42. These elements will be described later.

The server side display unit 36 has a server side display panel 44 such as a liquid display panel or the like, and it displays various kinds of information on the server side display panel 44 under the control of the server side controller 35.

The server side operating unit 37 is connected to an input device such as a keyboard, a mouth or the like, and it detects an operation to the input device and outputs the detected operation as an operation signal to the server side controller 35.

The storage unit 38 has a non-volatile storage device such as a hard disk or the like, and rewritably stores various kinds of data. A member DB 46 and a temporary member DB 47 are stored in the storage unit 38, and this will be described later. The interface unit 39 performs communications based on a communication protocol under the control of the server side controller 35.

According to the in-vehicle mount type battery charging system 1 of this embodiment, a user who has been pre-registered as a member can utilize the charger 12 of the charging station 14.

The registration of members and the utilization of the chargers 12 will be described briefly hereunder.

A user accesses the managing server 10 to make a request for member registration by using a personal computer (not shown) connected to a cellular phone 17 or the Internet. When a user makes a request for member registration, the user notifies his/her personal information such as his/her name, the telephone number, the address, the mail address, etc. and information concerning his/her credit card to the managing server 10. The managing server 10 executes predetermined proceedings such as identity verification, credit inquiry, etc. to a card issuance company on the basis of the various kinds of information notified by the user, and then registers the user concerned as a member.

When the user is registered as a member, the managing server 10 notifies unique ID and a password corresponding to the unique ID to the user registered as the member by means of an electronic mail, mailing or the like, or issues an exclusive IC card. Furthermore, the managing server 10 stores the various kinds of information notified from the user at the request time of the member registration, ID and the password notified to the user concerned and the card ID of the IC card issued to the user concerned in association with one another in the member DB 46 stored in the storage unit 38.

Subsequently, when a user as a member charges his/her in-vehicle mount battery by using a charger 12 in a charging station 14, the user inputs ID and the password allocated to the user concerned by utilizing the touch panel 29 of the charger 12, and makes the IC card reader 23 of the charger 12 read the IC card issued to the user for user authentication. For the user authentication, the user may execute his/her authentication by using another IC card owned by himself/herself without using any issued exclusive IC card. The authentication using an IC card as described above is executed according to the same method as authentication using an IC card by a non-member as described later, and thus it will be described in detail later.

The charger side controller 20 of the charger 12 outputs the input ID and password to the server side controller 35 of the managing server 10, and outputs the read-out card ID to the server side controller 35 of the managing server 10. The server side controller 35 of the managing server 10 refers to the member DB 46 stored in the storage unit 38 on the basis of the ID and the password or the card ID input from the charger 12 to determine whether the user concerned is a registered member, and outputs a determination result to the charger side controller 20 of the charger 12. When the user concerned is a registered member, the charger side controller 20 controls the charging power supply unit 24 to enable charging using the charger 12. On the other hand, when the user concerned is not a registered member, the charger side controller 20 controls the charging power supply unit 24 to disable charging using the charger 12.

As described above, in the in-vehicle mount battery charging system 1 according to the embodiment, users who have been pre-registered as members are allowed to use the chargers 12 in the charging stations 14 for the following reason.

That is, the charging stations 14 are based on the assumption that they are operated in an unmanned style from the viewpoint of reduction in operating cost, reduction in proprietary area, conditions of location, etc. In this case, it is necessary to surely perform accounting (charging) based on use of the charging stations 14. In order to surely perform the accounting, it is considered that each charging station 14 is provided with an accounting (charging) device into which money can be put. In this case, the accounting device itself is relatively expensive, and also costs associated with supplement of change, collection of money, periodical maintenance, etc. occur, so that the operational cost increases. According to this embodiment, in consideration of this fact, the members who have been pre-registered are allowed to use the chargers 12 by using their credit cards or the like, and the accounting based on use of the charging stations 14 can be surely performed by using the credit cards or the like. Therefore, the operational cost of this embodiment can be more greatly reduced as compared with the case where the accounting device is installed.

Furthermore, the charge of the in-vehicle mount battery through the charger 12 has a characteristic that the electric power rate per unit for charging is hardly calculated unlike supplement of gasoline to a gasoline vehicle and an occurring expense is low. This induces such a situation that the accounting based on a metered (pay-as-you-go) rate is not proper. In consideration of this fact, it is assumed to apply an accounting system in which the expense for one charging operation is set to a fixed value or charge to an in-vehicle mount battery could be performed at any time every month if a fixed money is paid per month. In consideration of the application of the accounting system as described above, such an operation that a predetermined amount of money is debited from each member's credit card every month on the assumption that an agreement on the application of the accounting system described above is obtained from each member is optimally implemented.

Furthermore, not only members but also nonmembers require to charge their in-vehicle mount batteries as early possible because the residual capacities of the in-vehicle mount batteries decrease under running of electric vehicles. In this case, in a case where only pre-registered members are allowed to use the charging stations 14, non members cannot use any charging station 12 of the charging stations 14 in spite of reduction of the residual capacities of the in-vehicle mount batteries, so that the convenience for users as nonmembers is lost. The loss of the convenience for users may become a factor of disturbing propagation of electric vehicles.

In consideration of this fact, according to the in-vehicle mount battery charging system 1 according to this embodiment, by executing the following operation, the cost can be reduced without providing any accounting device, and users as nonmembers are also allowed to use the chargers 12 of the charging stations 14 on the assumption that the accounting (charging) based on use of the chargers 12 is surely executed.

The operation of the in-vehicle mount type battery charging system 1 will be described hereunder with reference to flowcharts.

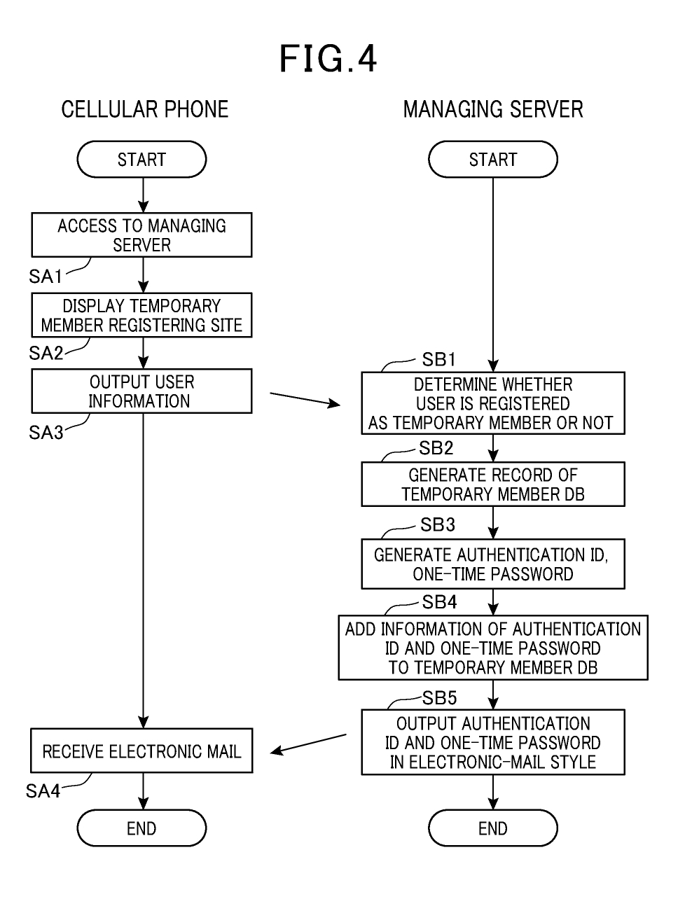

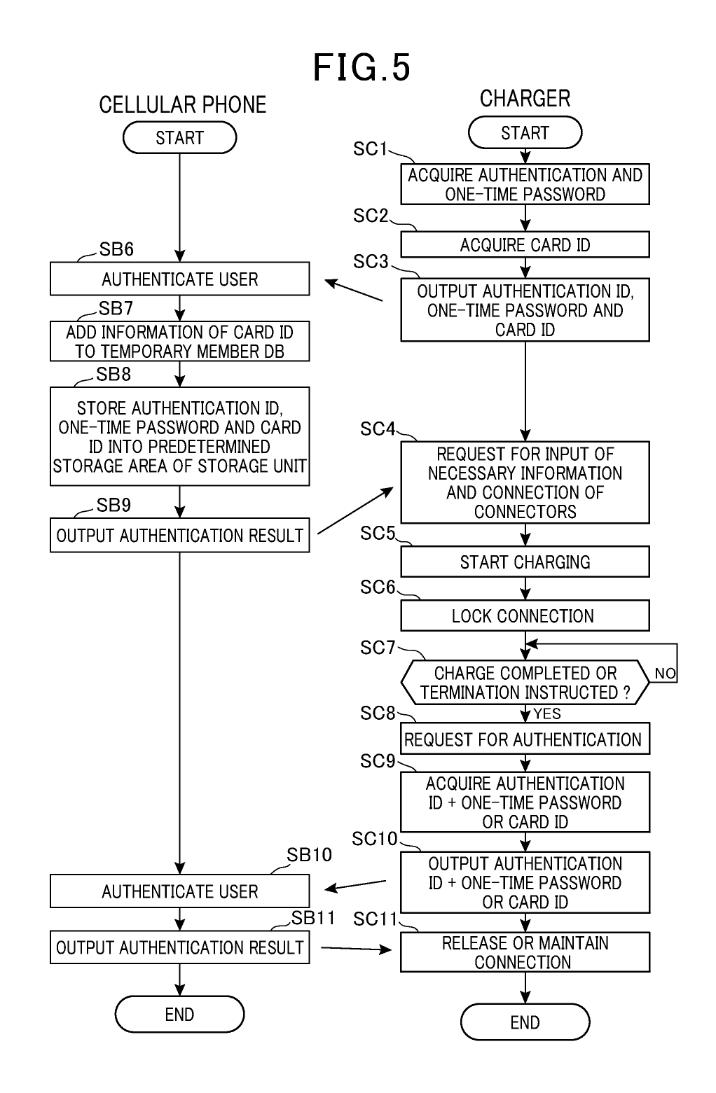

FIGS. 4 and 5 are sequence flowcharts showing the operation of the in-vehicle mount type battery charging system 1. Particularly, FIG. 4 shows the operation of the cellular phone 17 and the operation of the managing server 10, and FIG. 5 shows the operation of the managing server 10 and the operation of the charger 12.

Furthermore, in the following description, it is assumed that the residual capacity of the in-vehicle mount battery of the electric vehicle of a user as a nonmember decreases and thus the user concerned stops the electric vehicle at a nearest charging station 14.

Still furthermore, in the following description, it is assumed that a user has an IC card based on a standard under which it is readable by the IC card reader 23.

First, a user as a nonmember requests registration of a temporary member to the managing server 10. The temporary member is a person who is qualified to temporarily use chargers 12 of charging stations 14, and the user as the member can use the chargers 12 of the charging stations 14 by registering himself/herself as a temporary member.

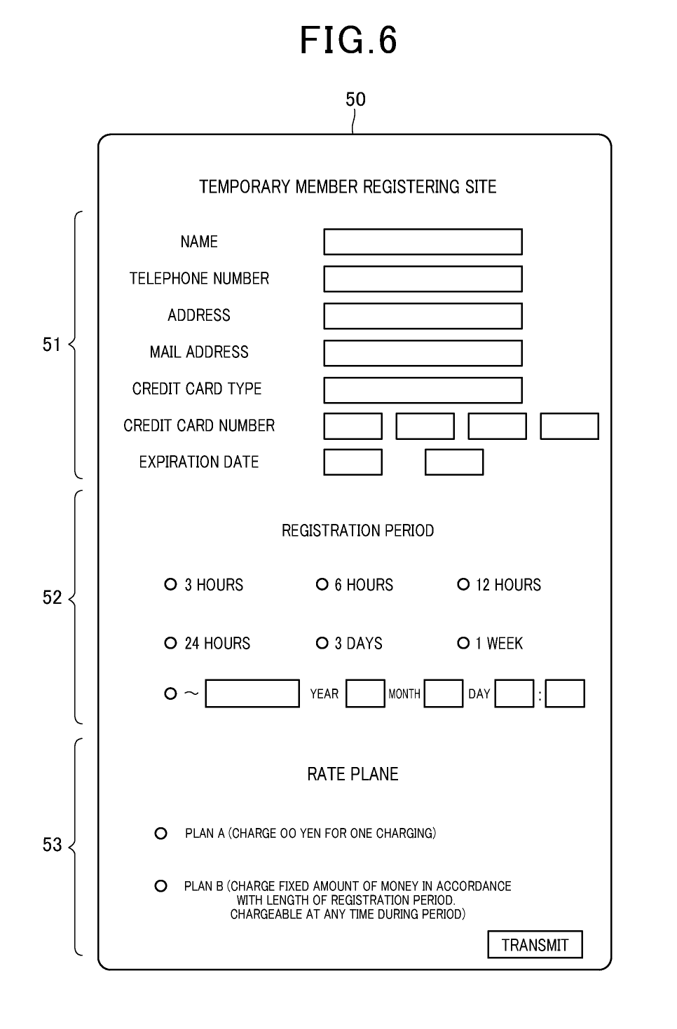

Specifically, referring to FIG. 4, the user as the nonmember accesses the managing server 10 by the cellular phone 17 (step SA1) to display a temporary member registering site 50 (FIG. 6) open for temporary member registration on the cellular phone 17 (step SA2).

In this embodiment, URL of the temporary member registering site 50 is displayed on the charger side display panel 27 of the charger 12, and a two-dimensional bar code for accessing the temporary member registering site 50 is displayed. When the cellular phone 17 is provided with a camera which is designed to read a two-dimensional bar code, the user reads the two-dimensional code by using the cellular phone 17 to access the temporary member registering site 50, and when not so, the user accesses the temporary member registering site 50 on the basis of URL displayed on the charger side display panel 27.

FIG. 6 is a diagram showing an example of the temporary member registering site 50.

As shown in FIG. 6, a user information input area 51 is formed in the temporary member registering site 50 so that user's name, the telephone number, the address, the mail address of the cellular phone 17, the type of the credit card, the number of the credit card and the expiration date.

A registration period selecting area 52 is formed in the temporary member registering site 50, and the user checks a corresponding radio button so that the user can select a period for which the registration of the temporary member is continued (hereinafter referred to as “temporary-member registration period”). In this embodiment, the temporary-member registration period may be set to any period from the start point corresponding to completion of the temporary-member registration till any period of three hours, six hours, twelve hours, 24 hours, three days and one week elapses or till a date and hour (date and time) which the user can input by himself/herself has come. As described above, each user can select the temporary-member registration period. Therefore, a user who is going to secure electric power for his/her in-vehicle mount battery in the meantime until the user comes back home and then charges the in-vehicle mount battery by using a commercial power supply after the user arrives at his/her home selects “three hours”, and a user who rents an electric car selects the period corresponding to a residual rental period. That is, the user can flexibly and properly select the optimum registration period in accordance with a situation inherent to each user.

A rate plane selecting area 53 is formed in the temporary member registering site 50. As shown in FIG. 6, by checking a radio button, a plan A or a plan B as a rate plan can be selected.

The plan A is a rate plan in which a predetermined fixed amount of money is charged. The plan B is a rate plan in which a fixed amount of money is charged in accordance with a temporary member registration period selected in the registration period selecting area 52 by a user and the user can charge the user's in-vehicle mount battery at any time for the period concerned. The relationship between the registration period and the fixed amount of money is displayed as information on the charger side display panel 27 of the charger 12, and the user can grasp the relationship concerned by referring to this information.

As described above, the plans A and B are plans which are proposed in consideration of the characteristic inherent to electric vehicles that the rate per unit for power charging of the in-vehicle mount battery is hardly calculated and the charging rate is low. As compared with the metered-rate accounting, these planes are optimum as the rate plan associated with the charging of the in-vehicle mount battery.

Returning to the sequence flowchart of FIG. 4, after the temporary member registering site 50 is displayed in step SA2, the user inputs each item of the temporary member registering site 50 and checks a necessary radio button to input information necessary for temporary member registration. Specifically, the user inputs his/her name, the telephone number, the address, the mail address of the cellular phone 17, the credit card type, the credit card number and the expiration date in the user information input area 51, selects a temporary-member registration period in the registration period selecting area 52 and selects the plan A or the plan B in the rate plan selecting area 53.

After input information necessary for temporary member registration, the user selects a transmission button 54 of the temporary member registering site 50. An input content is settled (entered) in response to the selection of this transmission button 54 as a trigger, and also each kind of input information is output to the server side controller 35 of the managing server 10 (step SA3).

After the information necessary for the temporary member registration in step SA3 is input, the temporary member registering unit 40 of the server side controller 35 of the managing server 10 determines whether the user is registered as a temporary member or not (step SB1). Software and hardware cooperate with each other like CPU of the server side controller 35 executes a program stored in ROM or the like, thereby implementing the function of the temporary member registering unit 40.

Here, the operation of the temporary member registering unit 40 in step SB1 will be described in detail.

The temporary member registering unit 40 executes identity verification and credit inquiry of the user on the credit card system 18 by using the credit card type, the credit card number and the expiration date out of the information input to the temporary member registering site 50 by the user.

The credit card system is a system which is supplied by a credit card issuing company or an affiliated store managing company for managing affiliated stores, and it has at least a settlement function using a credit card and a function of executing identity verification and credit inquiry on the basis of the credit card number and the expiration date. The temporary member registering unit 40 executes communications concerning the above inquiry to the credit card system 18 corresponding to the credit card type input by the user.

When the temporary member registering unit 40 determines on the basis of the result of the identity verification and the credit inquiry that the usage fee (rate) of the charger 12 can be charged by using the user's credit card, the temporary member registering unit 40 determines to register the user concerned as a temporary member. On the other hand, when it is determined that the usage fee (rate) of the charger 12 cannot be charged by using the user's credit card, the temporary member registering unit 40 ceases to register the user concerned as a temporary member. As described above, according to this embodiment, only when the accounting (charging) using the credit card is possible, the user is registered as a temporary member. Accordingly, the accounting to users can be surely implemented. Particularly, the accounting can be performed by using the credit card, and thus the sure accounting to the users can be implemented without providing any accounting device while implementing the reduction of the cost.

Subsequently, when it is determined that the user concerned is registered as a temporary member, the temporary member registering unit 40 accesses the temporary member DB 47 stored in the storage unit 38 to generate one-case record for the user concerned (step SB2). In this embodiment, it corresponds to the “temporary member registration” that one-case record is generated in the temporary member DB 47 for the user who is determined to be registered as a temporary member.

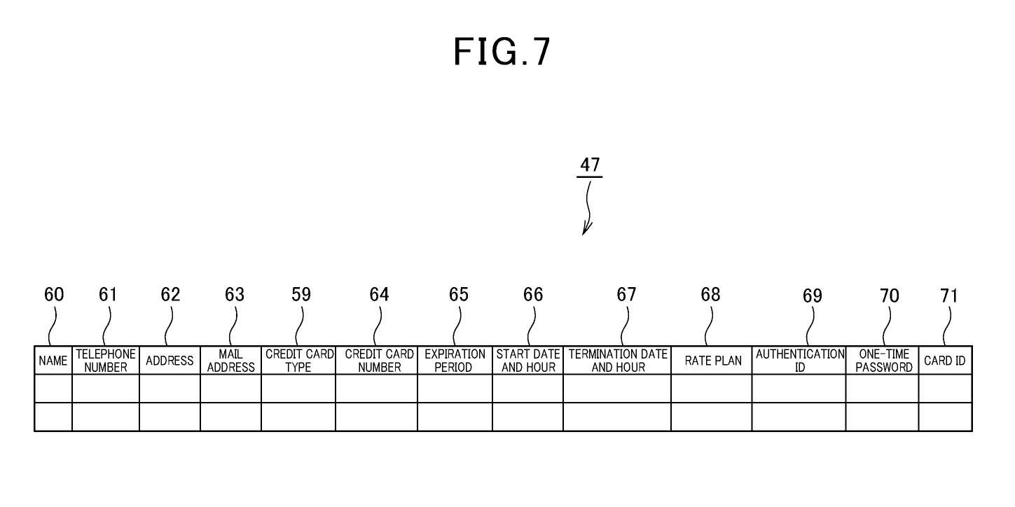

FIG. 7 is a diagram showing the construction of the temporary member DB 47.

As shown in FIG. 7, the one-case record of the temporary member DB 47 contains a name field 60 in which data representing the names of users are stored, a telephone number field 61 in which data representing telephone numbers are stored, an address field 62 in which data representing addresses are stored, a mail address field 63 in which data representing mail addresses of cellular phones 17, a credit card type field 59 in which data representing credit card types are stored, a credit card number field 64 in which data representing credit card numbers are stored, and an expiration date field 65 in which data representing expiration dates are stored. The data stored in each of the fields are generated on the basis of the information input in the user information input area 51 of the temporary member registering site 50 by users.

Each one-case record of the temporary member DB 47 contains a start date-and-hour field 66 in which data representing the date and hour for starting temporary member registration, and a termination date-and-hour field 67 in which data representing the date and hour at which the temporary member registration is terminated. The data stored in the start date-and-hour field 66 represents the date and hour at which the temporary member registration is executed. Furthermore, in the termination date-and-hour field 67 is stored the data representing the “the date and hour at which the registration period is finished” which is calculated on the basis of the date and hour represented by the data stored in the start date-and-hour field 66 and the registration period selected by the user in the registration period selecting area 52 of the temporary member registering site 50. For example, when the start date and hour is set to 2010/01/01/10:00 and the registration period selected by the user in the registration period selecting area 52 of the temporary member registering site 50, data representing 2010/01/01/16:00 is stored in the termination date-and-hour field 67.

Furthermore, a rate plan field 68 in which data representing a rate plan is contained in one-case record of the temporary member DB 47. The data representing the rate plan which is selected by the user in the rate plan selecting area 53 of the temporary member registering site 50 is stored in the rate plan field 68.

In addition, the one-case record of the temporary member DB 47 contains an authentication ID field 69, a one-time password field 70 and a card ID field 71. The data stored in these fields will be described later.

Returning to the sequence flowchart of FIG. 4, after a one-case record is generated in the temporary member DB 47 for a user who is determined to be registered as a temporary member, the one-time password issuing unit 41 of the server side controller 35 generates authentication ID inherent to the user registered as a temporary member, and also generates the one-time password corresponding to the authentication ID (step SB3). The authentication ID and the one-time password are generated by using an existing algorithm. The function of the one-time password issuing unit 41 is implemented by the cooperation between software and hardware like CPU of the server side controller 35 executes a program stored in ROM or the like.

Subsequently, the one-time password issuing unit 41 stores the data representing the generated authentication ID in the authentication ID field 69 of the record of the temporary member DB47 generated in step SB2, and the data representing the generated one-time password is stored in the one-time password field 70 (step SB4).

Subsequently, the one-time password issuing unit 41 refers to the mail address field 63 of the temporary member DB 47 to achieve the mail address of the user's cellular phone 17, and also notifies the authentication ID and the one-time password generated in step SB3 to the user in an electronic mail style (step SB5).

The cellular phone 17 receives an electronic mail transmitted from the one-time password issuing unit 41 (step SA4). The user achieves the authentication ID issued to himself/herself and the one-time password by referring to the received electronic mail.

Referring to FIG. 5, the user who obtains the authentication ID issued to himself/herself and the one-time password in step SA (FIG. 4) touches the touch panel 29 while referring to the charger side display unit 21 to display an ID password input screen for inputting the authentication ID and the one-time password for authenticating the user on the charger side display panel 27, and inputs the thus-obtained authentication ID and one-time password onto the ID password input screen. Accordingly, the charger side controller 20 of the charger 12 achieves the authentication ID and the one-time password input by the user (step SC1).

Furthermore, in combination with the input of the authentication ID and the one-time password, the user applies his/her own IC card to the IC card reader 23 so that the IC card is read by the IC card reader 23, whereby the charger side controller 20 achieves the card ID of the IC card (step SC2).

Subsequently, the charger side controller 20 outputs the authentication ID and the one-time password obtained in step SC1 and the card ID obtained in step SC2 to the server side controller 35 of the managing server 10 through the Internet 11 (step SC3).

The user authentication unit 42 of the server side controller 35 to which the authentication ID, the one-time password and the card ID are input from the charger side controller 20 determines on the basis of the input authentication ID and one-time password whether the user has been registered as a temporary member (step SB6). The function of the user authenticating unit 42 is implemented by the cooperation between software and hardware like CPU of the server side controller 35 executes a program stored in ROM or the like.

Specifically, the user authenticating unit 42 accesses the temporary member DB 47 and refers to the authentication ID field 69 and the one-time password field 70. When a record in which the data representing the authentication ID input from the charger side controller 20 and the data representing the one-time password are stored exists in each field, it is determined that the user has been registered as a temporary member. When the corresponding record does not exist, it is determined that the user has not been registered as a temporary member.

When it is determined that the user has not been registered as a temporary member, the user authenticating unit 42 notifies this fact to the charger side controller 20. The charger side controller 20 receiving this notification controls the charging power supply unit 24 so that it is impossible to perform charging by using the charger 12. Here, in order to clarify the description, it is assumed in the following description that it is determined that the user has been registered as a temporary member.

Subsequently, the server side controller 35 accesses the temporary member DB 47 and stores the data representing the card ID input from the charger side controller 20 into the card ID field 71 of the specified record in step SB6 (step SB7).

In step SB7, the data representing the card ID is stored in the card ID field 71, whereby the user may execute a very simple work of applying the IC card to the IC card reader 23 for user authentication to make the IC card reader 23 read the IC card. Therefore, it is unnecessary to perform a cumbersome work of inputting the authentication ID and the one-time password. Specifically, when the user authentication is executed, the user makes the IC card reader 23 to read the IC card. Accordingly, the charger side controller 20 achieves the card ID of the IC card and outputs the achieved card ID to the server side controller 35. The server side controller 35 to which the card ID is input refers to the card ID field 71 of the temporary member DB 47. Then, when there exists a record in which the data representing the input card ID is stored in the card ID field 71, the user is determined as a temporary member. On the other hand, when the record concerned does not exist, the user is determined not to be a temporary member.

Subsequently, the server side controller 35 stores the data representing the authentication ID, the one-time password and the card ID respectively into a predetermined recording area of the storage unit 38 (step SB8). Here, the stored data are used for user authentication which is performed when a charging connector 25 described later is connected to a connector at the in-vehicle mount battery side.

Subsequently, the server side controller 35 outputs, to the charger side controller 20, data representing an authentication result, that is, data containing information representing whether the user has been registered as a temporary member or not (step SB9).

The charger side controller 20 to which the authentication result is input displays, on the charger side display panel 27, a request for promoting the user to input information (for example, charging method) necessary for charging based on the charger 12 such as a charging method or the like, and also displays to promote the user to connect the charging connector 25 and the connector at the in-vehicle mount battery side (step SC4).

When the user instructs to start charging after the user inputs the information necessary for the charging such as the charging method or the like and then connects the charging connector 25 to the connector at the in-vehicle mount battery side on the basis of the display content of the charger side display panel 27 in step SC4, the charger side controller 20 controls the charging power supply unit 24 to start the charging to the in-vehicle mount battery (step SC5). In combination with this operation, the lock unit 26 of the charger side controller 20 controls the lock mechanism 31 to lock the connection between the charging connector 25 and the connector at the in-vehicle mount battery side (step SC6).

Subsequently, the charger side controller 20 monitors whether the charging is completed or not or whether termination (stop) of the charging is instructed or not (step SC7). When the charging is completed or the termination of the charging is instructed (step SC7: YES), the charger side display unit 21 is controlled to display, on the charger side display unit 27, a request for promoting the user to input the authentication ID and the one-time password or making the IC card reader 23 read the IC card for user authentication (step SC8).

In order to clarify the description, when the user makes the IC card reader 23 read the IC card in response to the request of the step SC8, the charger side controller 20 acquires the card ID of the IC card (step SC9), and outputs the acquired card ID to the server side controller 35.

The server side controller 35 to which the card ID is input compares the value of the card ID stored in the predetermined storage area of the storage unit 38 in step SB8 with the value of the card ID output from the charger side controller 20 in step SC10 to perform user authentication (step SB10). The authentication in this step SB10 aims to confirm whether the connection between the charging connector 25 and the connector at the in-vehicle mount battery is about to be released by the user who starts the charge based on the charger 12. When the value of the card ID stored in the storage unit 38 in step SB8 is coincident with the value of the card ID output from the charger side controller 20 in step SC10, the user who starts the charge using the charger 12 is identified as the same person as the user who is releasing the connection between the charging connector 25 and the connector at the in-vehicle battery side. On the other hand, when the values of these card IDs are different from each other, the user who start the charge using the charger 12 is identified as a person different from the user who is releasing the connection between these connectors.

when the user inputs the authentication ID and the one-time password in response to the authentication request in step SC8, the server side controller 35 performs the user authentication on the basis of the comparison between the authentication ID and the one-time password stored in the predetermined storage area of the storage unit 38 in step SB8 and the authentication ID and the one-time password input by the user in step SB10.

Subsequently, the server side controller 35 outputs the authentication result of the step SB10 to the charger side controller 20 (step SB11).

When the authentication result indicates that the user who starts the charge based on the charger 12 is identified as the same person as the user who is releasing the connection between the connectors, the lock unit 26 of the charger side controller 20 to which the authentication result is input controls the lock mechanism 31 to release the lock between the connectors. On the other hand, when the authentication result indicates that the user who starts the charge based on the charger 12 is identified as a different person from the user who is releasing the connection between the connectors, the lock between the connectors by the lock mechanism 31 is maintained (step SC11).

As described above, according to this embodiment, when the connection between the charging connector 25 and the connector at the in-vehicle mount battery side is released, the user authentication is performed, and the connection between the connectors is released only when the user who starts the charge is identified as the same person as the user who is releasing the connection between the connectors. Accordingly, there can be prevented occurrence of such a situation that another person releases the connection between the charging connector 25 and the connector at the in-vehicle battery side to charge the in-vehicle mount battery of his/her electric vehicle without user's consent while the user as the temporary member charges his/her in-vehicle mount battery.

Particularly, the charging time required for the charge based on the charger 12 in the electric station trends to be longer as compared with supplement of gasoline to a gasoline vehicle in a gasoline station, and thus there is such a situation that a user goes to a shop to purchase drink or gets away from his/her vehicle to take a rest under charging. Even in this case, there can be surely prevented occurrence of such as situation that another person releases the connection between the charging connector 25 and the connector at the in-vehicle mount battery side without user's consent to charge the in-vehicle mount battery of the other person's electric vehicle.

As described above, according to this embodiment, the managing server 10 receives member registration from a user, authenticates the user concerned when the user concerned uses a charger 12, and allows the user to use the charger 12 when the user concerned is a registered member. Furthermore, the managing server 10 receives temporary member registration from a user as a nonmember, and allows the user concerned to use a charger 12 when the user concerned is identified as a registered temporary member as a user authentication result which is obtained when the user concerned uses a charger 12.

Accordingly, not only pre-registered members, but also temporary members can use the chargers 12 of the charging stations 14, and thus nonmembers can charge their in-vehicle mount batteries in each charging station 14, so that the convenience of this charging system can be enhanced.

Furthermore, according to this embodiment, the charger side controller 20 of the charger 12 has a lock unit 26 for locking the connection between the charging connector 25 and the connector at the in-vehicle mount battery side. In a case where the user concerned is identified as a registered member or a registered temporary member as a user authentication result by the managing server 10 when the user concerned uses a charger 12, the connection between the charging connector 25 and the connector at the in-vehicle mount battery side is locked by the lock unit 26 in accordance with user's start instruction of charging. In addition, when the lock is released by the lock unit 26, the user authentication is executed by the managing server 10, and when the user concerned is identified as the user who starts the charging as the authentication result, the lock of the lock unit 26 is released.

Accordingly, registered members and registered temporary members can start use of chargers 12. Therefore, it can be prevented that accounting (charging) is not surely performed due to use of a nonmember and also a nonmember uses a charger 12 without prior consent. Furthermore, in order to release the lock between the charging connector 25 and the in-vehicle mount battery side connector, it is required to authenticate (identify) the user concerned as a person who starts the charge, and there can be prevented occurrence of such a situation that another person different from the user releases the connection between the charger and the in-vehicle mount battery without user's consent during charging to charge the in-vehicle mount battery of the other person's electric vehicle.

Particularly, with respect to the charge based on the charger 12 in the charging station 14, the time required for charging trends to be longer as compared with supplement of gasoline in a gasoline station, and a user may get away from his/her vehicle during charging. Even in this case, there can be surely prevented occurrence of such a situation that another person releases the connection between the charger and the in-vehicle mount battery without user's consent to charge the in-vehicle mount battery of the other person's electric vehicle.

Furthermore, according to this embodiment, the temporary member registration is set to be valid during a fixed period. Accordingly, the temporary member registration can be set to be valid for a properly determined fixed period.

Still furthermore, according to this embodiment, the managing server 10 is further provided with the one-time password issuing unit 41 for generating a one-time password for each temporary member and outputting the generated one-time password to the user. The charging station 14 is provided with the user interface (touch panel 29) through which the user can input his/her one-time password. The managing server 10 compares the one-time password input through the touch panel 29 by the user with the one-time password generated for the user by the one-time password issuing unit 41 when the user uses the charger 12, and determines on the basis of this comparison whether the user concerned has been registered as a temporary member or not.

Accordingly, the temporary member registration can be properly performed on any user who requests temporary member registration by using one-time password, and a user as a temporary member can surely use chargers 12.

Furthermore, the charging station 14 is provided with the IC card reader 23 which can read the card ID from the IC card. When a user whose card ID is not registered in the temporary member DB 47 is authenticated, the managing server 10 acquires the card ID of a user's IC card by the IC card reader 23 in combination with the authentication, and stores the acquired card ID in association with the user information in the temporary member DB 47. The managing server 10 reads the card ID of the IC card by the IC card reader 23 to authenticate the user whose card ID is stored in the temporary member DB 47, and authenticates the user concerned on the basis of the user information stored in association with the read-out card ID.

Accordingly, after the card ID is once stored by the managing server 10, the authentication of a user who owns the IC card corresponding to the card ID concerned is performed on the basis of the stored card ID. Accordingly, the user may make the IC card reader 23 read his/her IC card for user authentication, and a labor imposed on the user for authentication can be reduced as compared with the case where it is necessary to input a one-time password or the like for authentication, so that the convenience of this system can be enhanced.

Furthermore, according to this embodiment, when receiving the temporary member registration from a user, the managing server 10 requests the user to input necessary matters such as user's name, the credit card type, the credit card number, the expiration date, etc., and selects on the basis of the input necessary matters whether the user concerned is registered as a temporary member or not.

Accordingly, it is properly determined whether the user should be allowed to use the charger 12, and then it is properly selected whether the user concerned is registered as a temporary member.

Furthermore, according to this embodiment, the necessary matters to be input by the user when the user requests the temporary member registration contain the credit card type, the credit card number and the expiration date which are used to determine whether the user concerned can be charged or not (i.e., the accounting to the user is possible or not). When receiving the temporary member registration from the user, the managing server 10 requests the user to input the necessary matters, and determines on the basis of the input necessary matters whether the user concerned can be charged or not. When it is determined that the user concerned can be charged, the user concerned is registered as a temporary member.

According to this construction, when the user can be charged, the temporary member registration of the user can be performed, and thus the sure as the temporary member who has used the charger of the charging station can be surely charged.

### Second Embodiment

Next, a second embodiment will be described.

In the first embodiment described above, authentication ID for authentication and one-time password are issued to a user by the one-time password issuing unit 41, and the user inputs the authentication ID and the one-time password issued to himself/herself by using the touch panel 29 in at least first user authentication.

The work of inputting the authentication ID and the one-time password is cumbersome, and some input error may occur. According to the second embodiment, in consideration of this fact, when user authentication is executed, the work which the user is required to perform is simplified, and occurrence of input error is prevented.

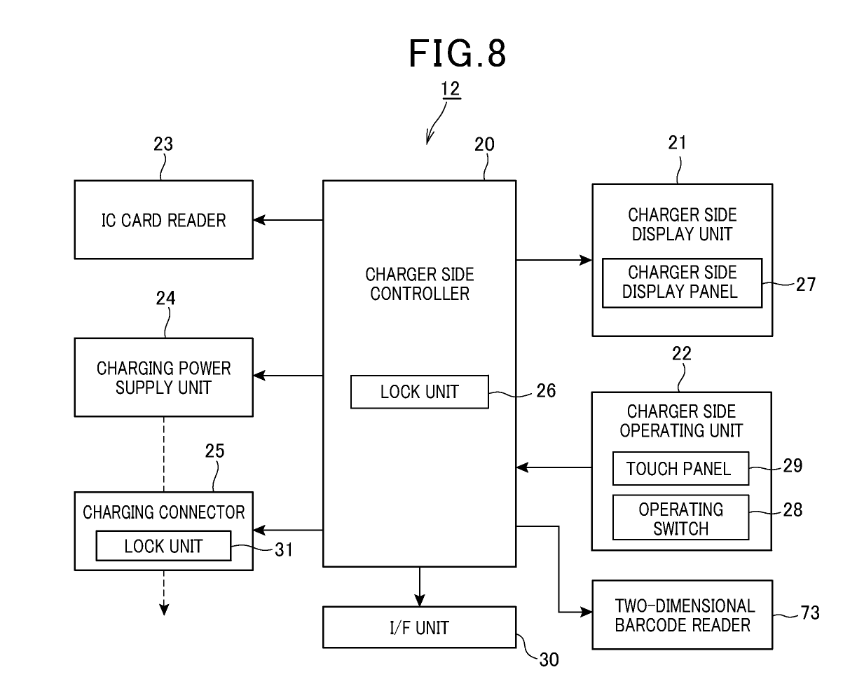

FIG. 8 is a block diagram showing the functional construction of the charger 12 according to this embodiment.

As is apparent from the comparison between FIG. 2 and FIG. 8, the charger 12 according to this embodiment is further provided with a two-dimensional bar-code reader 73 (authentication code reading device) which can read a two-dimensional bar code.

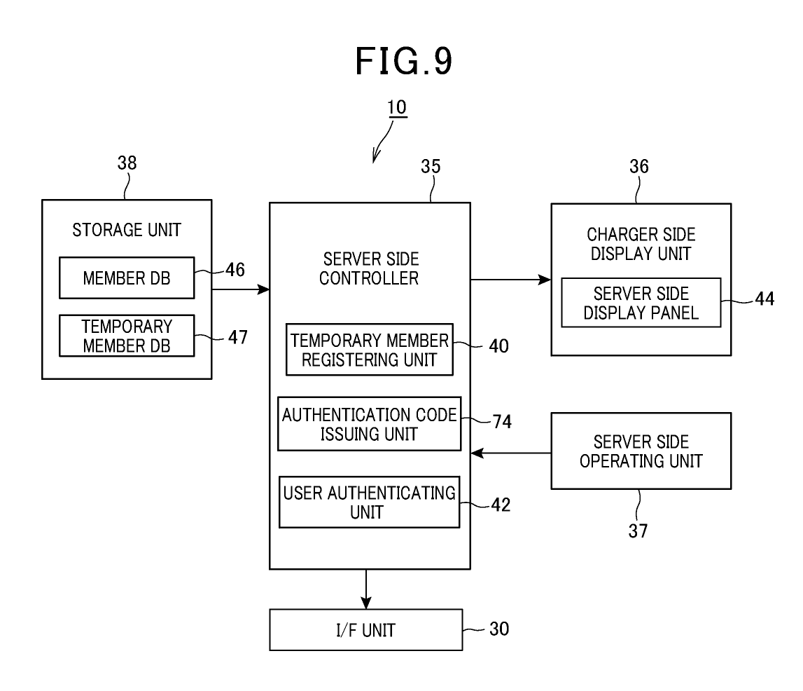

FIG. 9 is a block diagram showing the functional construction of the managing server 10 according to this embodiment. As is apparent from the comparison between FIG. 3 and FIG. 9, the managing server 10 according to this embodiment has an authentication code issuing unit 74 in place of the one-time password issuing unit 41.

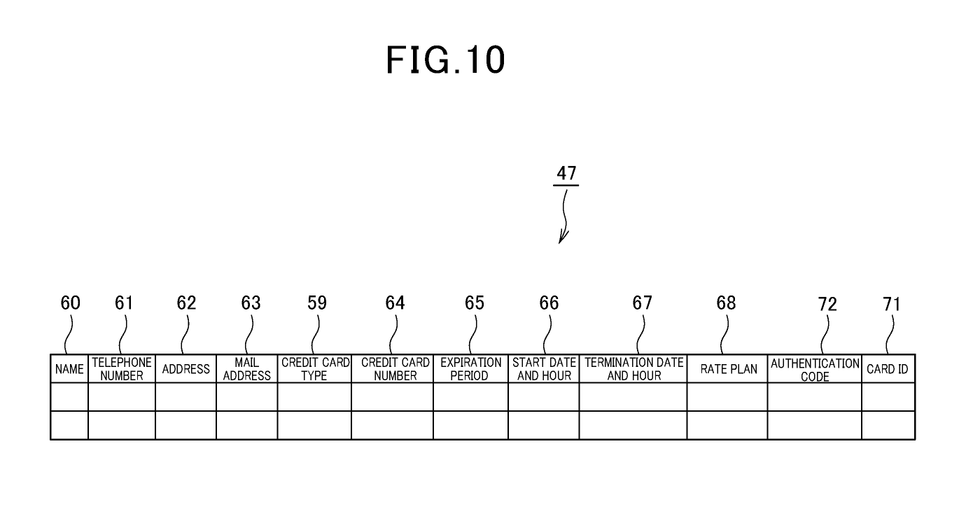

FIG. 10 is a diagram showing the construction of the temporary member DB 47 according to this embodiment. As is apparent from the comparison between FIG. 7 and FIG. 10, one-case record of the temporary member DB 47 according to this embodiment has an authentication code field 72 in place of the authentication ID field 69 and the one-time password field 70.

Next, the operation of the in-vehicle mount type charging system 1 according to this embodiment will be described with reference to FIG. 4.

In this embodiment, a series of operations of the steps SB3 to SB5 and the step SA4 of FIG. 4 are different from the operation of the first embodiment described above.

That is, in step SB3, the authentication code issuing unit 74 of the server side controller 35 generates user ID to be uniquely allocated to a user registered as a temporary member, and generates a two-dimensional bar code for authentication (authentication code) representing the user ID on the basis of the user ID concerned. The function of the authentication code issuing unit 47 is implemented by the cooperation between software and hardware like CPU of the server side controller 35 executes a program stored in ROM, etc.

In subsequent step SB4, the authentication code issuing unit 74 stores the user ID represented by the generated two-dimensional bar code into the authentication code field 72 of the record of the temporary member DB4 generated in step SB2.

In subsequent step SB5, the authentication code issuing unit 74 refers to the mail address field 63 of the temporary member DB 47 to acquire the mail address of the cellular phone 17 of the user and also outputs the image corresponding to the generated two-dimensional bar code to the user in an electronic mail style.

In step SA4, the cellular phone 17 receives an electronic mail transmitted by the authentication code issuing unit 74. The user opens the received electronic mail to display the image of the two-dimensional bar code generated by the authentication code issuing unit 74 in a display area of the cellular phone 17.

The two-dimensional bar code is used in the following manner when user authentication is executed.

That is, when user authentication is executed, the user displays the two-dimensional bar code in the display area of the cellular phone 17, and also makes the two-dimensional bar-code reader 73 of the charger 12 read the two-dimensional bar code. The work of making the two-dimensional bar-code reader 73 read the two-dimensional bar code displayed in the display area of the cellular phone 17 is very simple and thus no input error occurs as compared with the work of inputting the authentication ID and the one-time password as in the case of the first embodiment.

The charger side controller 20 converts the two-dimensional bar code read out by the two-dimensional bar-code reader 73 to the user ID, and outputs the user ID concerned to the server side controller 35. The server side controller 35 to which the user ID is input refers to the authentication code field 72 of the temporary member DB 47. When there exists a record in which the data representing the user ID input from the charger side controller 20 is stored in the authentication code field 72, the server side controller 35 identifies the user as a temporary member. On the other hand, when the record concerned does not exist, the server side controller 35 determines that the user is not any temporary member.

As described above, according to this embodiment, the managing server 10 has the authentication code issuing unit 74 for generating a two-dimensional bar code for authentication on the basis of the user ID which is uniquely allocated to the user concerned when receiving the temporary member registration from a user, and outputting the generated two-dimensional bar code to the user. The charging station 14 is provided with the two-dimensional bar-code reader which can read two-dimensional bar codes. When the user uses a charger 12, the managing server 10 determines on the basis of the two-dimensional bar code read out by the two-dimensional bar-code reader whether the user concerned has been registered as a temporary member or not.

Accordingly, when the authentication is executed, the user may make the two-dimensional bar-code reader read the two-dimensional bar code given to the user concerned. Accordingly, when the authentication is executed, the work which the user is required to execute for the authentication can be reduced as compared with the case where the user is required to input the one-time password or the like.

### Third Embodiment

Next, a third embodiment will be described.

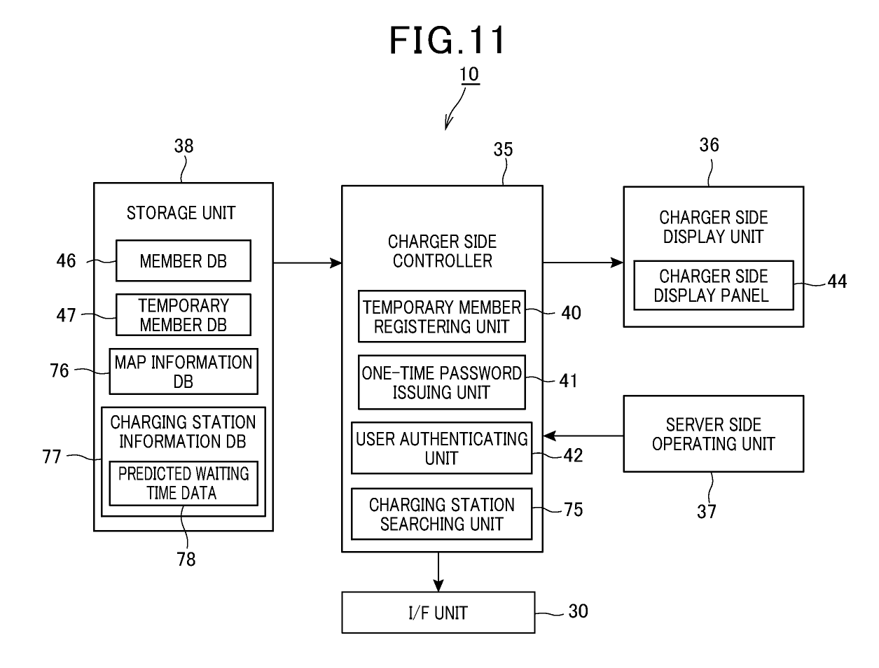

FIG. 11 is a block diagram showing the functional construction of the managing server 10 according to this embodiment. As is apparent from the comparison between FIG. 11 and FIG. 3, the server side controller 35 is further provided with a charging station searching unit 75. Furthermore, as shown in FIG. 11, the storage unit 38 further stores a map information DB 76 and a charging station information DB 77.

The map information DB 76 is a data base for storing data concerning maps, and contains data concerning information such as roads, facilities, etc. on maps. The map information DB 76 contains information (longitude, latitude, etc.) representing the positions of the charging stations 14 existing on the maps. That is, the server side controller 35 can acquire the positions of the charging stations on the maps by referring to the map information DB 76. Furthermore, the map information DB 76 has link data concerning interval routes (links) sectioned every predetermined unit with respect to roads existing on the maps, and node data concerning cross-points (nodes). The link data and the node data contain information concerning road types, road widths, lane numbers, one-way traffic or not and speed limit, and link cost data representing link costs of respective links. The link cost of each link is calculated from the length of the link, the type of the link, an average travel time, etc.

The charging station information DB 77 is a data base for storing information concerning each charging station 14. Particularly, estimated waiting time data are stored in the charging station information DB 77. The estimated waiting time data 78 is a time estimated as a waiting time which occurs until charging is started by using a charger 12 in a charging station 14 after an electric vehicle arrives at the charging station 14. For example, the estimated waiting time data 78 is calculated by the server side controller 35 as described below. That is, the status of utilization of a charger 12 concerned (start of charging, during charging, termination (stop) of charging, etc.) is output from the charger 12 of the charging station 14 to the server side controller 35 on a real-time basis. The server side controller 35 calculates the degree of congestion of each charging station 14 through predetermined statistical processing on the basis of the status of utilization of each charger 12 input on a real-time basis and the accumulated past status of utilization of each charger 12, and also calculates the estimated waiting time on the basis of the calculated degree of congestion.

The first embodiment described above is implemented on the assumption that when a user as a nonmember wishes to charge his/her in-vehicle mount battery during running, the user stops his/her electric vehicle at the nearest charging station 14, and takes the procedure for the temporary member registration.

However, there are many cases in which the user does not grasp an available charging station 14 during running, and also it is generally expected that the user wishes to be registered as a temporary member on the assumption that the user grasps an optimum charging station 14 for himself/herself in view of the waiting time and the positional relationship between the present place and the charging station.

According to this embodiment, in consideration of these factors, prior to the temporary member registration, the user is provided with information useful to determine whether the user is registered as a temporary member, whereby the user can make the above determination properly.

In the following description, it is assumed that a user possesses a cellular phone 17 and beforehand knows URL for accessing the temporary member registering site 50 and also the user can access the temporary member registering site 50 with the cellular phone 17 by using an Internet searching service or the like. Furthermore, it is also assumed that the cellular phone 17 has a function of achieving area information from a base station 15 or a GPS function and can achieve present position information by using these functions.

Furthermore, in the following description, it is assumed that the user temporarily stops his/her electric vehicle and operate the cellular phone 17 without operating the cellular phone 17 during driving of the electric vehicle or another passenger operates the cellular phone 17 in place of the driver.

First, the user which wishes to be registered as a nonmember during running accesses the temporary member registering site 50 by using the cellular phone 17. In this embodiment, not only an area for inputting information necessary for temporary member registration (see the first embodiment), but also a charging station search button is formed in the temporary member registering site 50.

When the charging station search button is operated by the user, this fact and the position information of the cellular phone 17 are output to the server side controller 35.

In response to these information as a trigger, the charging station search unit 75 of the server side controller 35 refers to the map information DB 76 and the charging station information DB 77 on the basis of the input position information to search charging stations 14 within a predetermined distance (for example, 30 km) from the present position of the electric vehicle (the position indicated by the position information of the cellular phone 17). Furthermore, the charging station search unit 75 specifies the optimum charging station 14 from the searched charging stations 14 for the user.

Specifically, the charging station search unit 75 specifies a charging station 14 under the condition that the sum of an estimated time required until the electric vehicle reaches the charging station 14 concerned from the present place of the electric vehicle and an estimated waiting time occurring until the charge of the electric vehicle is started after the electric vehicle arrives at the charging station 14 concerned is minimum. “The estimated time required until the electric vehicle reaches the charging station 14 from the present place of the electric vehicle” is properly determined while optimum routes extending to the respective charging stations 14 are searched by using the link cost and the link data, the node data and the link cost data are reflected. The estimated waiting time occurring until the charging is started is properly determined by using the estimated waiting time data 789 of the charging station information DB 77. The server side controller 35 displays the search result of the charging station search unit 75 in the display area of the cellular phone 17.

Accordingly, the user can grasp available charging stations 14 existing around the present place before the user is registered as a temporary member, and further grasp the optimum charging station 14 for the user concerned. Accordingly, the user can cancel temporary member registration when no charging station 14 exists around the present place or the like. Furthermore, there can be prevented occurrence of such a situation that the user has no opportunity for using a charging station 14 although the user has been registered as a member or the user cannot finally use any charging station 14 although the user pays for temporary member registration. Particularly, this situation peculiarly occurs due to the fact that the in-vehicle mount type battery charging system 1 adopts not the metered-rate based charging (accounting) system, but the fixed-rate based charging (accounting) system. However, according to this embodiment, occurrence of such a peculiar situation can be suitably prevented.

As described above, according to this embodiment, the managing server 10 is configured so as to receive temporary member registration using a cellular phone 17 from a user, and when receiving the temporary member registration based on the cellular phone 17 from the user, on the basis of the position information of the cellular phone 17, the managing server 10 searches charging stations 14 which the user concerned can use, and supplies the search result to the user concerned through the cellular phone 17. Accordingly, the user can recognize usable charging stations 14 for him/her in accordance with his/her position, and acquire information useful to determine whether he/she should be registered as a temporary member or not, so that the convenience of this system for users can be enhanced.

The present invention is not limited to the above-described embodiments, and any modification and application may be made without departing from the subject matter of the present invention.

For example, in the above embodiments, it is determined on the basis of the information supplied from the credit card system whether accounting (charging) can be performed on users. However, whether accounting (charging) is possible or impossible may be determined on the basis of other information, for example, information obtained by using the accounting system of the cellular phone or the like.

In the above-described embodiments, the cellular phone 17 is applied as a portable terminal. However, the portable terminal is not limited to the cellular phone 17, and it may be a mobile type car navigation system or the like which can access the managing server 10.

What is claimed is:

1. An in-vehicle mount type battery charging system comprising:
a charging station having a charger for charging an in-vehicle mount battery of an electric vehicle; and
a managing server that is connected to the charger of the charging station so that communications can be performed between the managing server and the charger, wherein the managing server has a member authenticating function of receiving registration for enabling use of the charger from a user, authenticating the user when the user uses the charger and allowing the user to use the charger when the user is authenticated as a registered member, and a temporary member authenticating function of receiving temporary registration for temporarily enabling use of the charger from a user as a nonmember, authenticating the user when the user uses the charger and temporarily allowing the user to use the charger when the user is authenticated as a registered temporary member.

2. The in-vehicle mount type battery charging system, further comprising a lock unit for locking connection between the charger and the in-vehicle mount battery, wherein when a user uses the charger, the connection between the charger and the in-vehicle mount battery is locked by the lock unit in accordance with user's instruction of starting charging under a condition that the user is authenticated as any one of a registered member and a registered temporary member by the managing server, and when a user releases the lock of the connection between the charger and the in-vehicle mount battery by the lock unit, the lock of the connection by the lock unit is released under a condition that the managing server authenticates the user as a user who starts the charging.

3. The in-vehicle mount type battery charging system according to claim 1, wherein the temporary registration of the managing server is set to be valid for a fixed period.

4. The in-vehicle mount type battery charging system according to claim 1, wherein the managing server is configured to receive temporary member registration from a user through a portable terminal, and the managing server is provided with a charging station searching unit for searching charging stations available to a user on the basis of position information of the portable terminal and outputting information concerning the searched charging stations to the user through the portable terminal when the managing server receives temporary member registration from the user.

5. The in-vehicle mount type battery charging system according to claim 4, wherein the managing server is further provided with a one-time password issuing unit for generating a one-time password for a temporary member and allocating the generated one-time password to a user when the managing server receives temporary member registration from the user, the charging station is provided with a user interface to which the user can input the one-time password allocated to the user concerned, and when a user uses the charger, the managing server determines on the basis of comparison between the one-time password input through the user interface by the user and the one-time password generated by the one-time password issuing unit whether the user has been registered as a temporary member.

6. The in-vehicle mount type battery charging system according to claim 1, wherein the managing server is further provided with an authentication code issuing unit for generating an authentication code uniquely allocated to a user and outputting the generated authentication code to the user when the managing server receives temporary member registration from the user, the charging station is provided with an authentication code reading device for reading an authentication code, and the managing server determines on the basis of the authentication code read out by the authentication code reading device whether the user has been registered as a temporary member.

7. The in-vehicle mount type battery charging system according to claim 1, wherein the charging station is provided with a card reading device that can read a card ID from an authentication card, and wherein when a user whose card ID is not stored is authenticated, the managing server acquires the card ID of the authentication card by the card reading device in combination with the authentication of the user, stores the acquired card ID in association with user information containing at least information concerning whether the user is a temporary member or not, and when a user whose card ID is stored is authenticated, the managing server acquires the card ID of the authentication card by the card reading device, and authenticates the user on the basis of user information stored in association with the read card ID.

8. The in-vehicle mount type battery charging system according to claim 1, wherein when receiving temporary member registration from a user, the managing server requests the user to input necessary matters for the temporary member registration, and selects on the basis of the input necessary matters whether the user should be registered as a temporary member.

9. The in-vehicle mount type battery charging system according to claim 8, wherein the necessary matters contain a matter for identifying whether accounting can be applied to the user or not, and when receiving temporary member registration from a user, the managing server requests the user to input necessary matters, determines on the basis of the input necessary matters whether accounting can be applied to the user, and registers the user as a temporary member when it is determined that accounting can be applied to the user.

10. A managing server that is connected to a charger provided in a charging station to charge an in-vehicle mount battery of an electric vehicle so that communications can be performed between the managing server and the charger, wherein the managing server has a member authenticating function of receiving registration for enabling use of the charger from a user, authenticating the user when the user uses the charger and allowing the user to use the charger when the user is authenticated as a registered member, and a temporary member authenticating function of receiving temporary registration for temporarily enabling use of the charger from a user as a nonmember, authenticating the user when the user uses the charger and temporarily allowing the user to use the charger when the user is authenticated as a registered temporary member.

11. A method of controlling a managing server that is connected to a charger provided in a charging station to charge an in-vehicle mount battery of an electric vehicle so that communications can be performed between the managing server and the charger, comprising:
receiving registration for enabling use of the charger from a first user;
authenticating the first user when the first user uses the charger;
allowing the first user to use the charger when the first user is authenticated as a registered member;
receiving temporary registration for temporarily enabling use of the charger from a second user as a nonmember;
authenticating the second user when the second user uses the charger; and
temporarily allowing the second user to use the charger when the second user is authenticated as a registered temporary member.

12. A medium storing a computer-readable program for making a computer execute a procedure comprising the steps of:
receiving registration for enabling use of the charger from a first user;
authenticating the first user when the first user uses the charger;
allowing the first user to use the charger when the first user is authenticated as a registered member;
receiving temporary registration for temporarily enabling use of the charger from a second user as a nonmember;
authenticating the second user when the second user uses the charger; and
temporarily allowing the second user to use the charger when the second user is authenticated as a registered temporary member.
